(19) United States
(12) Patent Application Publication
(10) Pub. No.: US 2012/0089292 A1
(43) Pub. Date: Apr. 12, 2012

(54) Architecture and Interface for a Device-Extensible Distributed Navigation System

(76) Inventors: Leonid Naimark, Brookline, MA (US); William H. Weedon, III, Warwick, RI (US); Marcos Antonio Bergamo, Wellesley, MA (US)

(21) Appl. No.: 13/026,226

(22) Filed: Feb. 12, 2011

Related U.S. Application Data
(60) Provisional application No. 61/304,456, filed on Feb. 14, 2010.

(51) Int. Cl. G01C 21/00; G05D 1/00

(52) U.S. Cl. 701/23; 701/400

(57) ABSTRACT

A method for navigating a moving object (vehicle) utilizing a Navigation manager module and comprising the steps of: communicating with all sensors, processing units, mission manager and other vehicles navigation managers; configuring and reconfiguring sensors based on mission scenario objectives, in-vehicle and global constraints; sensor grouping according to relationship to the vehicle and environment, where an entire sensor group is seen by navigation manager as a single sensor; processing unit containing Update Filter; and a dynamically updated API database.

### NOTES TO OTHER APPLICATIONS

This application is a non-provisional filing of provisional application No. 61/304,456.

### FIELD OF THE INVENTION

The present invention relates generally to inertial navigation in GPS-denied environments and localization methods that integrate the use of diverse sensors distributed over different platforms including methods for cooperation among such sensors and platforms and opportunistic synchronization with GPS.

### OBJECTS AND SUMMARY OF THE INVENTION

It is an object of this invention to improve upon an Inertial Navigation System by allowing for updates from a Global Positioning Satellite System (GPS) to correct for navigation errors.

It is an object of this invention to combine the Inertial Navigation System with other sensors including hybrid sensors such as RF ranging and Navigation Technology, visual trackers and other sensing systems to create a navigation system that functions in a GPS deprived environment.

This invention is the realization that Inertial Navigation Systems can be improved by using a sensor-based navigation architecture that enables sensors, regardless of their type, nature and intrinsic capabilities to be robustly and cost-effectively incorporated into the navigation system of each mobile user (or vehicle) while leveraging and making optimum utilization of communication between such users. To achieve such robustness and cost effectiveness this navigation architecture incorporates a significant number of key enabling capabilities, which are briefly summarized below:

1. Architectural framework which drastically reduces the number of different interfaces and maximizes navigation performance through
Sensor grouping according to relationship to the vehicle, environment and locality of the reference coordinate system into three sensor groups, where an entire group is seen by navigation manager as a single sensor
Separation of update filter processing into two channels: one with fixed number of states representing single point-vector on a vehicle; another with limited number of states representing local environment based on local processing and network throughput capabilities

2. Architecture which dynamically configures and reconfigures based on
Mission scenario objectives including environment-dependent required level of navigation accuracy over mission life
In-vehicle (e.g., power consumption) and global (e.g., communications) constraints

3. Support for any type of sensor including sensor-vehicle interaction through
API database that can be updated dynamically;
Simplified sensor-processing interface through abstractions and objects that include “conversion” of “sensor measurement specifics” into processing-common “navigation objects” such that different types of sensors in each of three groups can be mixed and selected/matched by “processing” according to their “utility” for the navigation.

4. Support for intra- and inter-vehicle sensor configurations including flexible vehicles (e.g., human) and distributed mobile vehicles through flexible distributed vehicle maps.

### BRIEF DESCRIPTION OF THE DRAWINGS

FIG. 1 illustrates the proposed navigation architecture that achieves and/or enables the navigation capabilities of updating INS from a variety of sensors.

FIG. 2 illustrates key functions for the Global Navigation Manager.

FIG. 3 illustrates the structure of the proposed Global Sensors Group.

FIG. 4 illustrates the Vehicle-Referenced (VR) Sensor Group containing all sensors attached to the vehicle, which provide the vehicle pose (i.e., coordinates) and derivatives in current time relative to the vehicle post in past time(s).

FIG. 5 illustrates the EF sensors group architecture that includes communications with a second vehicle.

FIG. 6a describes the most elementary object consisting of one sensor S1 and one feature F1.

FIG. 6b illustrates when a common feature F1 is observed by two sensors S1 and S2 in the same vehicle.

FIG. 6c illustrates the case where features F1 and F2 are observed by same sensor S1, and features F1 and F2 are related to each other.

FIG. 7 shows a mission for a certain Vehicle A to travel from point S (Start) to point F (Finish) in at most one hour without a geolocation reset (within 2 m 3D rms), and reaching F with a maximum instantaneous location error of 10 m 3D rms).

FIG. 8 shows a vehicle is located at point A at time:

[symbol]

FIG. 9a depicts a sensor combination using two identical cameras mounted on the vehicle one after another along main direction of motion and facing down and forward.

### DETAILED DESCRIPTION OF THE PREFERRED EMBODIMENT

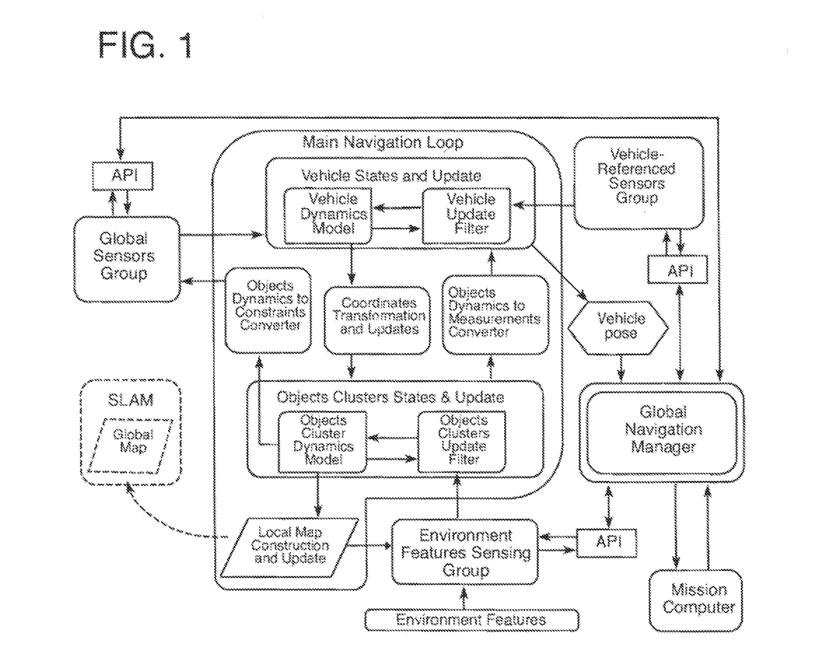

FIG. 1 is a block diagram that illustrates the proposed navigation architecture that achieves and/or enables the summarized navigation capabilities. The various types of sensors are grouped according to their relationship (i.e., attachment, access or visibility) to the vehicle itself, its immediate environment or World into three groups:

1. Vehicle-Referenced (VR) Sensors Group—VR sensors include all sensors attached to a vehicle and which provide vehicle pose and pose derivatives information in current time relative to the pose of the vehicle for previous times. Examples of VR sensors include IMU/INS, speedometers, accelerometers, gyroscopes, related encoders (e.g., for counting steps and measuring wheel rotation) and point referenced range/Doppler sensors.

2. Global (coordinates) Sensors Group (GSG)—GSG sensors include any sensor that can be used to fix and/or reduce the uncertainty of a vehicle's pose relative to the World (i.e., global coordinate system). It includes GPS, features (e.g., RF transmitter) populated at a known locations, road and building maps including the ability to determine if the vehicle is located near a specific feature (e.g., window, road intersection), smart maps including semantic references to features within a map, any type of “outside-in sensor” placed at a globally known location that senses the vehicle and transmits such information to the vehicle (e.g., video camera in a mall), and any pose constraint (e.g., confinement to a room or area).

3. Environment Features (EF) Sensing Group—EF sensors include any type of sensor that can detect a specific feature placed (e.g., paper fiducial, or standard of reference), located (e.g., light fixture, wall opening, etc.) or detected (e.g., edge, color gradient, texture) in the environment. Typically, these sensors have some form of feature labeling and mapping objects. Examples of EF sensors include: photo and video cameras, transmitters with identifiable temporal and/or spectrum characteristics (e.g., RF emitters including communication devices), transducers capable of detecting specific physical (e.g., magnetometers) or chemical properties.

In our architecture, in order to simplify the interfaces and facilitate the interaction between sensor groups, each sensor group contains:
Sensors
APIs and access to API database including update capability
Vehicle (flexible and distributed, when applicable) maps and mechanism of their update
Software modules to initialize, enumerate, switch on and off, calibrate and communicate with sensors
Processing modules (hardware and/or software) to pre-process sensor information merge information to form preferably a single rate output from the group to the Main Navigation Loop.

Specifically, in this architecture, each of these groups will compose a generalized sensor which we will refer to as “sensor group object”. Sensor group object includes-and-encapsulates the capabilities of discovering, identifying, initializing, calibrating, switching ON and OFF and, in general, communicating with corresponding sensors through an Application Programming Interface or API common and/or specific for the group. In addition to interfacing with corresponding sensors, the sensor group object will be capable of (1) selecting and/or merging measurement data and/or information from multiple sensors; (2) contributing to the update of corresponding “maps” such as to maximize the group contribution to the overall navigation system performance. In our architecture we focus on the APIs to enable flexible selection of participating sensors within each group, and on the corresponding abstractions including rules for merging data and information from otherwise different sensors.

Additionally, to simplify the interfaces, and since most of the “aiding” to navigation will result from each vehicle's interaction with the immediate environment and from networking, a related navigation encapsulated function was added into a “cluster navigation object.” Specifically, the Main Navigation Loop is composed, as per FIG. 1, of an Intra-Vehicle Navigation module that handles (i.e., track and update the states of vehicle point-vector) and a Cluster Navigation object or module that handles the dynamics of local (currently observable) feature-sensor objects (groups) distributed over the non-rigid vehicle and over multiple vehicles (i.e., networking). This Cluster Navigation object interacts with the “environment,” performs local map creation and updating and, importantly, generates the “dynamic constraints” for the overall navigation function. The Main Navigation Loop performs all the filtering and state processing related to navigation, including determining “constraints” for cluster formation. Global Navigation Manager performs all the system level function including evaluation of the navigation accuracy (Vehicle Pose) against Mission objectives and performing resources re-allocations or reconfigurations, when such change become necessary.

To simplify the interfaces and the functions performed by Cluster Navigation even further, the Environment Features group object includes novel “inheritance” abstractions. These abstractions, as described in the next section, simplifies the handling of multiple sensors (including heterogeneous sensors) distributed over multiple vehicles by converting and merging related measurements into a standard format within the Environment Features Sensing Group. This “inheritance abstraction” capability enables easy “plug-and-play” of environment-related aiding sensors to the overall navigation capability without requiring the same type of sensor (e.g., camera) to be installed in all participating vehicles.

Also importantly, the architecture object of this invention is not centered on simultaneous localization and mapping or SLAM's building. On the contrary, if “building a map” is included in the mission objective, and/or the building of such a map becomes relevant for the navigation (i.e., reduces the position uncertainty and/or enables locating the vehicle within a mission provided map or route), the system object of this invention can integrate SLAM as part of the Cluster Navigation capability.

In the following section, we provide a description of the detailed architecture including the internal structure of the various groups and their interaction with the Main Navigation Loop through an example CONOPS while focusing on two objectives of our proposed research: 1) simplify the aiding and integration of new sensors; 2) achieving mission navigation goals for long term position uncertainty while using aided sensing navigation.

### Detailed Architecture Description

Global Navigation Manager

The sensor API includes at least three levels: Core, Specific and Group. The Core-level API is common to all sensors and, in addition to sensor ID and type, information (or how to access information) about basic availability (e.g., ON/OFF and calibration status). The Specific-level API, as the name suggests, has information specific to the sensor (e.g., pixel sensitivity and shutter speed for camera, maximum update rate and noise for IMU or inertial measurement unit) including abstractions and rules governing the transformation of sensors specific measurements to position and/or navigation parameters that are common from all sensors in the group. The Group-level API includes parameters and rules that are common to the group (and meaningful for navigation) including rules relating power, processing and figures of merit (for navigation) and rules for merging its group-level measurements with corresponding measurements from other sensors in the same group. The Core-level is required while the Specific and Group-levels can be obtained from a database (local and/or accessible through the network). At initialization (or when a new sensor is plugged in), the “sensor group” reports to a Global Navigation Manager (GNM) every sensor that is available or become available. APIs may be missing and some sensors may not be calibrated. GNM is aware of mission requirements and eventually will become aware of all sensors in the system, including their availability and readiness (full API and calibrated) to be called upon use for navigation. The mission is dynamic and may call for different sensors at different “situations” and times. The mission requirement includes a cost/performance rules and, over the course of a mission, sensors may be activated, replaced or added as needed. Also, completing APIs and “calibrations” can be performed “on-the-fly.”

Typically, GNM reports the current positional accuracy of the vehicle to the Mission Computer. When the positional accuracy approaches the limit of acceptability (e.g., 9 m rms accuracy versus 10 m rms max), the Global Navigation Manager, or GNM advises Mission Computer about possible actions. These actions may include requesting more sensors and/or corresponding APIs, re-calibration of sensors, turning sensors ON/OFF, slowing the vehicle's motion, coming back along trajectory to reduce uncertainty and repeat last segment of the mission with added-on sensors to improve the local map, or communicate with other player to form a distributed vehicle.

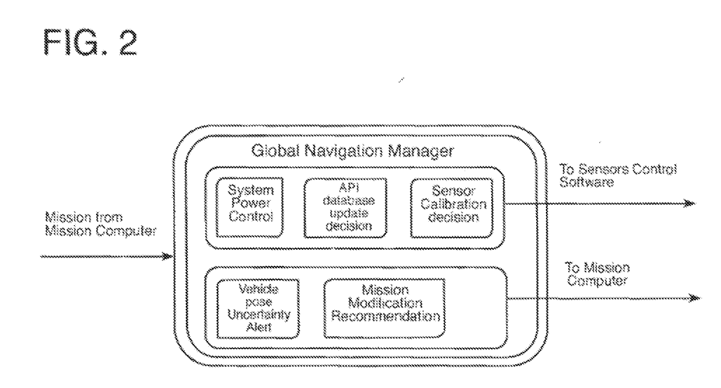

FIG. 2 illustrates key functions for the Global Navigation Manager. In the specific design of the API's, the representative mission scenarios and interactions between the various Sensor Groups and the GNM are designed with the objective simplifying the interfaces and maximizing the modularity and performance of the overall navigation function.

Finally and probably most importantly, GNM reports current positional accuracy of the vehicle to mission computer. In case when positional accuracy approaches limits of acceptable accuracy (for example vehicle gets to 9 m rms accuracy versus 10 m rms max acceptable accuracy and there is no GSG update expected soon to reduce uncertainty) GNM will advice Mission Computer about possible vehicle actions. Those actions may include requesting more APIs, calibration of yet not calibrated sensors, turning on power for currently unpowered sensors, slowing motion down, coming back along trajectory to reduce uncertainty and repeat last segment of the mission with added-on sensors to improve local map, or moving off trajectory mission toward the Global Sensors Group, or GSG, faster update or to meet and communicate with other player to form distributed vehicle.

Global Sensors Group

In general, any measurement from any sensor or source which reduces the global pose uncertainty can be interpreted belonging to the Global Sensors Group. The navigation system receives Geolocated updates at a certain rate (for example 1/hour) and the Geolocated measurement shall allows reducing the vehicle pose uncertainty (e.g., from 10 m rms to 2 m rms).

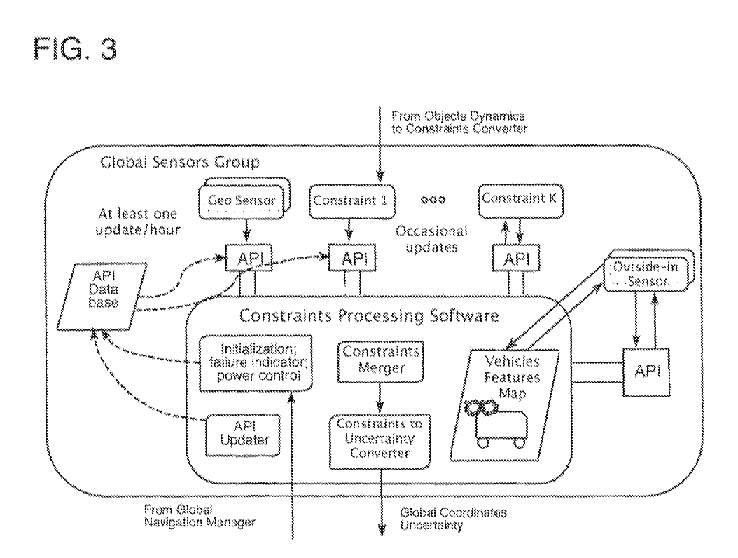

FIG. 3 illustrates the structure of the proposed Global Sensors Group. Please refer to FIG. 1 for the interactions (i.e., inputs and outputs) between the Global Sensor Group (GSG) and the Main Navigation Loop (MNL). GSG hides the details of interfacing with corresponding sensors (e.g., GPS, known or opportunistic RF sources, deployed features and pseudolites, etc.) by processing corresponding data locally and generating, for each sensor, position information in terms of absolute or global coordinates (including time) and associated uncertainties.

This API mechanism is the same for all sensor groups and API database can be shared by all sensors on the vehicle or each sensor group can have its own API database. In the case of GSG, Constraints Processing Software talks with any sensor through API. During enumeration phase (or new sensor addition phase) corresponding API is invoked from API Data Base. If vehicle computer does not have particular API it can send request through the network to obtain missing API. Other way to handle this is to download new APIs each time vehicle starts new mission. Either of those methods represents dynamical updated of API database.

In this architecture, in order to simplify the interfacing, we assume that each global sensor includes any hardware and/or software needed to determining corresponding coordinates and uncertainties over time. This allows for easy combination of measurements from a multitude of sensors such as to enable GSG to interact with MNL as a single sensor though a single Group-level API. In our architecture, the Group-level API includes the merging of the constraints that may arise from other types of sensors such as environment sensing. In certain configurations, several of such constraints can be received shortly one after another. For example, a vehicle may be seen simultaneously by two motion detection sensors placed at known poses in the environment such as to enable accurate vehicle location and/or reduction of corresponding location uncertainty. In this architecture, such constraints from multiple sensors are combined and acted together through a common Group-level API.

In general, it should be emphasized that some features (targets) can be installed on the vehicle (i.e., to be discovered by outside-in sensors). In this case, building a Vehicle Features Map may become relevant. In our architecture, such functionality, although typical of “environment sensing,” will be assumed to be an integral part of the outside-in sensor and included in Global Sensor Group. In our research we assessing the need for such functionality vis-a-vis mission requirements as the dimensions of a typical vehicle may be smaller than required position accuracy.

Vehicle Referenced Sensor Group

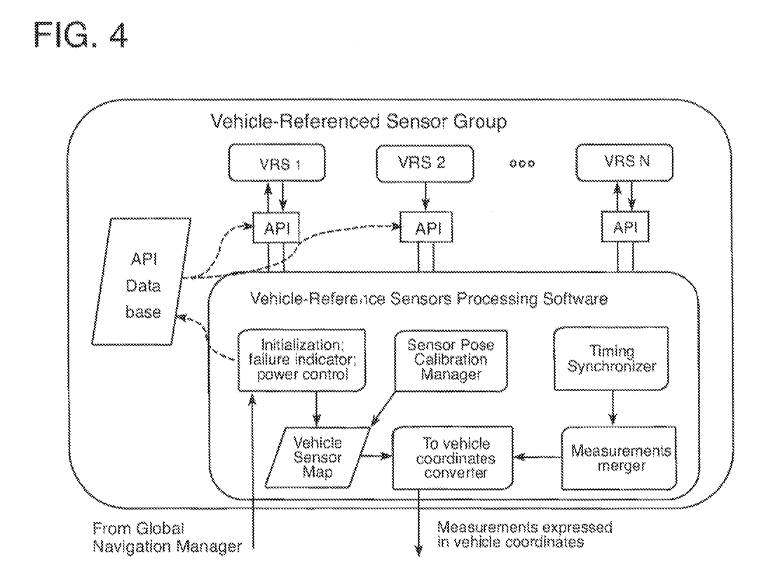

The Vehicle-Referenced (VR) Sensor Group, illustrated in FIG. 4, contains all sensors attached to the vehicle, which provide the vehicle pose (i.e., coordinates) and derivatives in current time relative to the vehicle post in past time(s). Examples of sensors in this group include IMU/INS, accelerometer and gyroscopes, speedometers, range and Doppler sensors, etc. VR group creates and maintains a Vehicle Sensor Map, which represents each sensor pose relative to a coordinate system fixed with respect to the Vehicle. Our sensor API, which includes a common “core” and “specific” components, facilitates the joining of new sensors and their calibration. In our architecture, a sensor participates in the overall navigation only if included the corresponding “group-level” API. In general, such an “inclusion” happen only if the newly added sensor can positively contribute (i.e., reduce uncertainties) to the overall navigation. Also, in our architecture, calibration may happen on the fly, and “joining the group” is handled and decided upon by the Global Navigation Manager, which can be centralized or distributed across the Vehicle and/or Sensor Groups depending on the vehicle physical extension and characteristics of the processing hardware (single or distributed microprocessors or cores).

The majority of sensors in VR sensor group generate information at a fixed rate determined by the specific hardware, and that may vary from sensor to sensor. Timing Synchronizer handles the various update rates, includes prediction, down-sampling and interpolation as required, and provides synchronized measurements to the Measurements Merger. Time Synchronizer also uses the capabilities of the Group-level API to facilitate the merger of measurements from different sensors.

Measurement Merger facilitated by the Group-level APIs included in these architecture groups and merges measurements of the similar type (e.g., angular velocity from a gyro and angular velocity from wheel encoder) and produces a single angular velocity measurement for the group. Overall, for sensors rigidly attached to the vehicle, all measurements are converted into 18-element vector in vehicle coordinate frame containing 3 positions, 3 orientations, and their first and second derivatives. Non-rigid vehicles are typically described in terms of rigid segments or part and joints and a complete description of the vehicles pose include an 18-coordinated measurement for each joint. Rigidity aspects of the vehicle may not be relevant at all times, and may vary with mission requirements and environment. In our architecture we will use the capabilities of the proposed Group-level API to simplify the interface (and the dimensionality) of the measurements VR exchanges with the Main Navigation Loop. Specifically, and whenever possible, we will integrate measurements inside the VR sensor group to provide only coordinates of the vehicle referenced a selected point (center of the body) while keeping dimensionality of output vector the same as in the case of a totally rigid vehicle. For this we will include descriptions including abstractions and processing rules relating to vehicles parts and rigidity in the corresponding Group-level API.

At the end, the VR sensor group contribution to the Main Navigation Loop of FIG. 1 is in the form of a single-pose measurement for the Vehicle, including derivatives. Information exchange between the VR sensor group and the Main Navigation Loop, including update rates and processing requirements, are defined and included in the corresponding Group-level API for the corresponding types of sensors. Typically, such an update rate is determined by IMU rate and real-time system processing requirements. Specifically, for the accuracy in the order of meters, an update rate of 60-100 updates per second will suffice.

Environment Features Sensing Group

Most of the navigation aiding capabilities (e.g., aiding to INS including updates and fixes from global sensors) will result from observations and interaction with the immediate environment and from networking with other vehicles. In our architecture, corresponding sensors, including interfacing, calibration, feature labeling, mapping, processing and “merging” are handled by the Environment Features (EF) sensing group. EF contains different types of sensors that can sense features located in immediate environment including: cameras (IR, UV, visible), magnetometers, radars and Laser ranging and detection or LADAR's, RF sensors and interaction with other vehicles through communications.

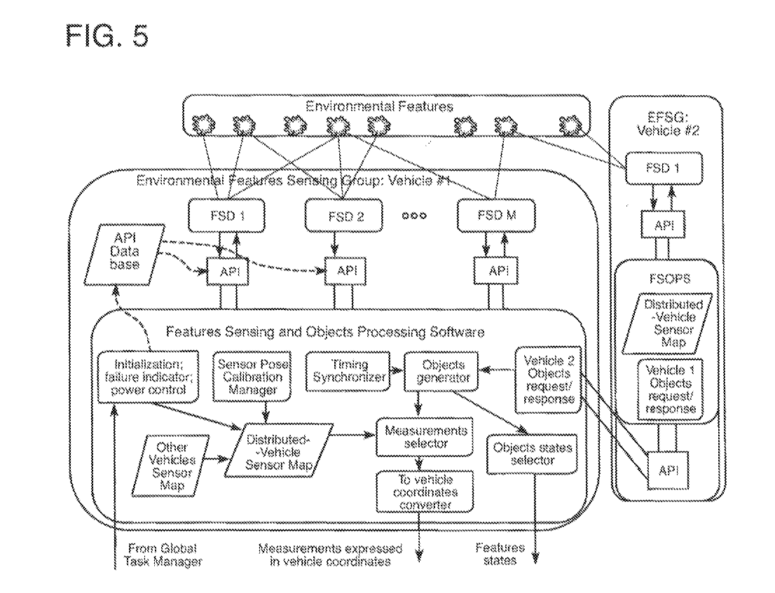

FIG. 5 illustrates the EF sensors group architecture that includes communications with a second vehicle. Functionally, the architecture is similar to the VR sensors group architecture as it includes API access and updating, initialization, calibration, timing synchronization and vehicle sensor mapping capabilities. Typical update rates for sensors in this group are lower than for the VR group, but the throughput and processing requirements can be quite different. Cameras for example may be capable of capturing 120 frames per second, however they generate lots of data such that associated feature extraction may be processing intensive and time consuming. Radar is another example of EF sensing that may be processing intensive and time consuming as one may require multiple scans before map updating can take place. Also the rates in which each sensor produces valuable navigation information can be quite different for different types of sensors. Although the types of information and associated throughputs and update rates can be different, the information they generate for navigation can be simplified and merged using descriptions, abstractions and merging rules included in the API, and in particular in the included Group-level API. In what follows we describe a case example involving exemplary two vehicles and EF sensors attached to such vehicles.

It makes sense for two vehicles to communicate with each other and exchange information if at least one of the following conditions holds:
Condition 1: Vehicle #1 is capable of measuring (or constraining) the pose of Vehicle #2 relative to the coordinate system attached to Vehicle #1 (i.e., referenced to Vehicle #1) and can report such an information back to Vehicle #2
Condition 2: Vehicles #1 and #2 sense the same feature and Vehicle #1 can transmit related information including related labeled feature properties to Vehicle #2

The overall navigation capability may (and probably will) benefit from the two-way exchange of pose related information including possibly pose information from multiple features. The actual beneficial value of such an exchange, including related communication and correlation processing costs has to be included and considered by the overall navigation capability. For this, in our architecture, we will structure the APIs for inter-vehicle communications to include rules that would enable assess the “navigational value” of each exchange for each of the sensors involved before any volume (and power) consuming transmission would take place. In the following paragraphs we present an exemplary scenario that we will analyze and expand in our research in order to come up with general rules that could be integrated in our APIs and processing, and then used by each vehicle on decisions related to communicating or not, including decisions about what to communicate and update rates of such a communications.

Let's assume two vehicles. In general, Vehicle #1 will decide about the navigational benefit of communicating with Vehicle #2 if it could receive three different types of information from Vehicle #2:
Vehicle #1 relative pose and Vehicle #2 global pose uncertainty: This information could be used to reduce pose uncertainty at Vehicle #1.
Vehicle #1 relative pose and Vehicle #2 Sensor Map: This information could be used to construct Distributed-Vehicle Sensor Map. This above map (illustrated by illustrated by the orange rhombuses in the figure) would constitute an extended or, in general, a Distributed Vehicle #1 which would incorporate and integrate the Vehicle maps of all neighboring nodes obtained through communication. Note that Distributed-Vehicle Sensor Map is a generalization of flexible sensor map. In a flexible map, relative sensor pose offsets are mechanically constrained, while in Distributed-Vehicle Sensor Map they are constrained only by the available communication (throughput and update rates) between neighbor nodes.
Labeled feature that is also recognized by sensors on Vehicle #1: In our architecture, this type of information is handled through Objects formation both on intra- and inter-vehicle level. This is described in details in the paragraphs that follow.

### Exemplary Objects and Inheritance Rules

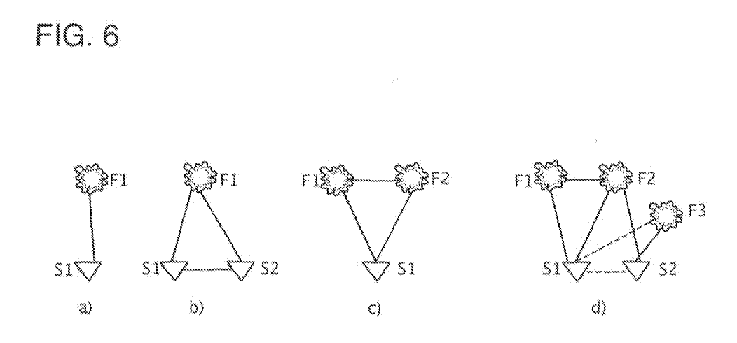

The most elementary object is the one consisting of one sensor S1 and one feature F1 (shown on FIG. 6a). When a common feature Fl is observed by two sensors S1 and S2 in the same vehicle (FIG. 6b), one can merge information about F1. If S1 and S2 are sensors of the same kind, one can improve an accuracy of the measurement by triangulating information from S1 and S2. For example, if two cameras provide two measurements of the bearing angle to a common feature, one can triangulate those measurements to increase the accuracy level related to the observation of such a feature.

If S1 and S2 are different types of sensors the generation of information in a way that is relevant and usable for navigation may require merging different types of information. For example, a camera providing bearing angle and rangefinder providing range to a common feature will effectively provide the 3-D coordinates of such a feature.

The next case is illustrated in FIG. 6c, where features F1 and F2 are observed by same sensor S1, and features F1 and F2 are related to each other (e.g., by some sort of rule including a connection). For example, radar observing a target comprised by 2 sub-parts with large cross-sections will instantaneously benefit from the knowledge that those sub-parts are rigidly connected.

The above relationships can be described by constructs from graph theory. Specifically, they can be formalized using the following set of definitions and rules:
Definition 1 (elementary object): An elementary object O is the one with one sensor and one feature connected.
Definition 2 (non-elementary object): A non-elementary object is the one with at least one loop (triangular), where each of participating nodes has at least 2 connections
Rule 1 (representation simplification): Each triangular can be replaced by elementary object by merging together either S nodes or F nodes. Let's turn out our attention to FIG. 6d while first assuming that both S1 and S2 belong to the same target. Suppose that S2 is not connected with F2. In this case this object can be split to two more simplistic non-elementary objects S1-F1-F2 and S1-S2-F3 by applying Rule 1 to the pairs F1-F2 and S1-S2 respectively. However, when connection F2-S2 is in place one cannot decompose object 6d into elementary objects. This leads to Rule 2 below:
Rule 2 (verification of non-elementary object): If by applying Rule 1 to each connected pair of F or S nodes one cannot form node with single connection, than such an object is non-elementary and cannot be decomposed.

Assume that sensor S1 belongs to Vehicle #1 and sensor S2 belongs to Vehicle #2. Then Vehicle #1 and #2 will initially have each two objects (S1-F1-F2 and S1-F3 for Vehicle #1 and S2-F2 and S2-F3 for Vehicle #2). Then by forming a Distributed Vehicle, in which Vehicle #1 inherits information from Vehicle #2, one can form more complex objects:
Definition 3: An object is inherited by Vehicle #1 from Vehicle #2 if the formation of such an object is made from more elementary objects originally presented in Vehicle #1 by adding connections from Vehicle 2.
Rule 3 (inheritance): An object can be inherited (resulting in larger object) if at least two features are simultaneously observed by sensors in both vehicles.

In our research, we will integrate both communications and graph theory constructs to create a rule-based API and object-based communications protocol such as to enable integrating the concepts of “distributed vehicles” in a way that they can enhance both each vehicle and overall combined vehicle navigation.

### Design and Performance Analysis for Specific AIDED-NAV

The described architecture framework allows to design different navigations systems with different performance, cost and size requirements. One could see that specific sensors selection heavily depends on mission requirements. In subsection 1 we present an exemplary worst-case mission scenario example. In subsection 2 we will show a preliminary design of a multi-sensor system that can handle such a mission. In remaining two subsections we present a short analysis of an exemplary IMU and Aiding sensors to be used in a navigation system.

IV.1 Exemplary Worst Case Mission Scenario and Uncertainty Propagation

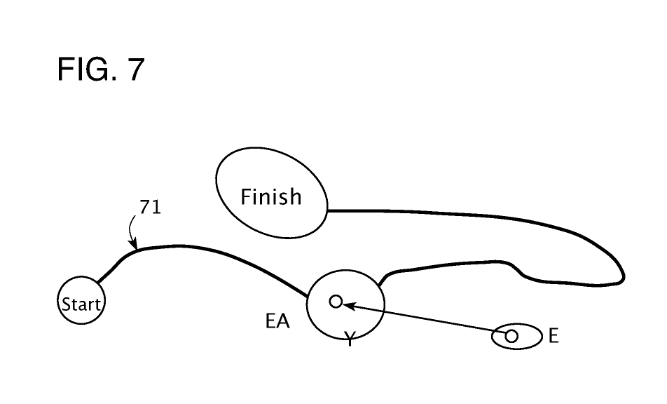

Suppose that the mission for a certain Vehicle A, as per Specification, is to travel from point S (Start) to point F (Finish) as depicted on FIG. 7 in at most one hour without a geolocation reset (within 2 m 3D rms), and reaching F with a maximum instantaneous location error of 10 m 3D rms). The vehicle has a maximum speed of Vmax (e.g., 12 km/h) and the distance between points S and F is 10 km. So, if the vehicle travels with maximum speed, it will take almost an hour arrive to point F. In this a case, the vehicle cannot go back to any point on the path, such that SLAM (that requires re-visiting points and/or re-tracing paths) is not an option.

The vehicle's pose uncertainty, 71, will grow until useful Global Referenced sensor information (not from GPS) is received, for example, Vehicle A meets Vehicle B (with positional uncertainty ellipse EB). Assume now that when Vehicle A reaches a generic intermediary point, Vehicle B measures its range to A with uncertainty in range and angle as depicted by yellow sector Y. The updated location of A based on a B-position error and range measurement can be calculated by adding the B-uncertainty ellipse EB for each point (i.e., centered at that point) of sector Y. As a result we obtain the B-based set EA(B) as the new uncertainty (i.e., A-uncertainty) for the Vehicle A. The intersection of this set with the original uncertainty set EA is the new decreased uncertainty set EA for A. Formally, for a generic time “t”, this can be written as

In the worst case however there is no Globally Referenced sensor information available before arrival to point F. Also there are no other vehicles participating in the mission (e.g., the path from S to F goes in the tunnel, while tunnel is curved such communication with points S and F is possible only at the very beginning and the very end of the mission respectively), so Vehicle A cannot improve its pose during the mission by exchanging information with other vehicles. In addition, there is no tunnel map. Also, to make the problem more realistic (and closer to a “worst case”), the tunnel has varying width that is wider than 10 m (i.e., larger than the maximum allowed uncertainty) and the tunnel is significantly curved such that, range and Doppler sensors can just be used just for limited times. Let's also assume that the tunnel walls are relatively smooth and uniformly colored, so there are not many features available for cameras. Finally, the tunnel floor is wet and slipping making wheel encoders not very accurate.

Exemplary Preliminary System Design

To fulfill the above mission, the navigation system will have to have accurate VR sensors, which will allow for the vehicle to cover an as long distance D as possible before reaching 10 m rms pose uncertainty. This distance D is calculated using only the VR sensors and, typically, for low-cost sensors will be just a fraction of the entire tunnel length. In order to slow down the growth of positional uncertainty, we will assume that the navigation system will have a number of EF sensors, which will provide accurate vehicle position updates relative to a segment of the local environment segment, such that pose accuracy will be almost unchangeable from the begging and the end of each segment.

Specifically, we assume a preliminary configurations consisting of the following sensors

0. GPS receiver (marked by 0 not to count it as one of “indoor” sensors)

1. IMU

2. Speedometer/wheel encoder

3. Laser rangefinder

4. Camera 1

5. Portable RF (radar) providing Range and Doppler

6a. Camera 2 factory mounted together with Camera 1

6b. Separate communication Channel

In what follows we provide exemplary initial characterization of the above sensors.

IV.3 Inertial Measurement Unit (IMU)

The typical Inertial Navigation System consists of 3 gyroscopes measuring angular velocity and 3 accelerometers measuring linear acceleration. Often other sensors such as a magnetometer, compass, inclinometer, altimeter, etc. are added to either provide some reference point or to compensate for local existing anomalies. Without going into specifics of different manufacturing technologies for inertial sensors, their accuracy is approximately a function of their size, weight and cost. When everything is reduced to the level of “miniature IMUs,” performance becomes an issue. Because of drifts in gyros and especially in accelerometers, typical miniature systems are capable of keeping reasonable positional accuracy for at most, several seconds. As an example, in 2009, InterSense released the first single-chip IMU-INS unit (called NavChip), which at the time outperformed other existing miniature IMUs. For AIDED-NAV we will use the NavChip as an INS benchmark subsystem. Relevant NavChip specifications are summarized in Table 1.

TABLE 1
Exemplary spec sheet (extracted for exemplary NavChip)

| Power Consumption | 120 mW | Weight | 6 grams |
|---|---|---|---|
| Angular Random Walk | 0.25 | Velocity Random Walk | 0.045 |

With the NavChip Angular Random Walk [symbol] , after the one hour mission (i.e., cross the tunnel) time, the Vehicle will have an accumulated an error of only 0.25 degrees of orientation uncertainty. However it can be easily calculated that for vehicle traveling for 1 hour with 10 km/h linear speed this angular uncertainty can be translated into about 40 meters of position uncertainty. The accumulated uncertainty of accelerometers of exemplary NavChip can be expressed as

[symbol]

The accelerometers will reach 10 m rms uncertainty in about 10 seconds, and about 108 m rms after one hour. The accelerometer performance can be enhanced with internal filters and tight integration with INS. In our system we will assume such a tight integration and internal filters such that, with the aiding accelerometers, we will be able to keep the vehicle within 10m uncertainty for about a minute.

Aiding Sensors

### Aiding Sensor #1: Accelerometers

To reduce uncertainty one can consider adding extra accelerometers (and gyros)

### Aiding Sensor #2: Speedometer and Steps Counting

Inexpensive speedometers in form of encoders or other devices capturing wheels motion are widely commercially available. Those devices are typically reported to provide linear speed with about 10% accuracy, meaning that for vehicle moving at 10 km/h it will take about a minute to reach 10m rms positional errors. For human motion an accelerometer, which counts steps can be considered as additional sensor also featuring about 10% accuracy in stride length estimation. Speedometers will also benefit from tight integration with INS. In this exercise we will assume that the combined INS +speedometers system would enable the system to be kept within 10 m rms for several minutes.

### Aiding Sensor #3: Rangefinder

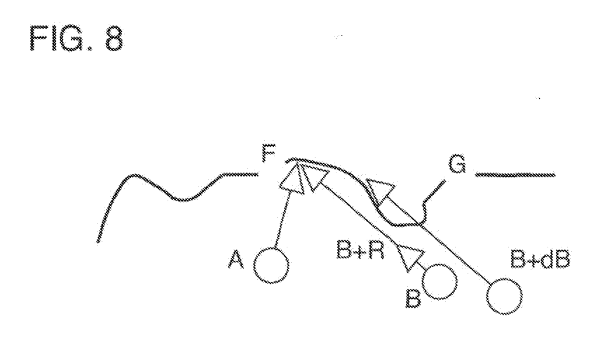

In this example, the vehicle is located at point A at time as depicted in FIG. 8. At this time the range finder receives perfect range information between points A and F. After one second ( ) the vehicle moves to point B according to INS. Due to INS uncertainty, the actual location of the vehicle is at point B+dB. Even if orientation is perfectly known range, the finder will shoot to point G rather than point F, resulting in additional positional error shown by red vector. Now, the hybrid INS+rangefinder system will provide B+R result as the new vehicle location.

It is important to notice that although the measurement updates from a simple range finder is typically instantaneous an generated at the same rate of the INS system, is typically not enough for an effective improvement of the positional uncertainty of the vehicle. Its usability can be improved when combined with a camera, described next.

Aiding Sensor #4: Camera

A single camera provides the bearing angle of a selected feature relative to the vehicle. If a range-finder is slaved to the camera, the then range to every feature can be added to bearing angle; this enables measuring all 6 coordinates of the feature F relative to the vehicle at time t and then recalculation of the vehicle pose for time t+1 until AIDED-NAV can sense another feature. Of course, at least 4 features are needed to unambiguously calculate the vehicle pose, and the more features one uses the more accurately the vehicle pose can be calculated.

Typical modern VGA camera (640×480 pixels) is capable of taking about 60 frames per second. The high-end models, (for instance cameras featuring Kodak KAI-0340M CCD chip), can go as fast as 210 frames/sec, but they are heavy, and require lots of power, making their use problematic on small platforms. CMOS cameras are considerably less expensive, ranging from below $100 till several hundred dollars. Exemplary best CMOS chips nowadays are manufactured by Micron (sold by Aptina Imaging Company) with particularly inexpensive high-quality Micron based cameras from PointGrey, Unibrain, IMI and others. Given that frames need to be captured, transferred to computer memory for processing and processed there, it is unlikely one will need cameras faster than 30 frames/sec. With 30 frames/sec or even slower rate one would expect to be able to have real-time processing on PDA or cell-phone type computer.

Aiding Sensor #5: Doppler and Range sensor

Portable Radar (or RF) sensors can be installed on the vehicle to simultaneously generate range and Doppler information. For short-range devices (with about 100 m range maximum), the required RF power is relatively low such that they are extensively used in commercial applications, including cell phones. In our navigation system, we will integrate radars of this type with two purposes:
Building more accurate maps by integrating them with cameras;
Keeping the 3D uncertainty almost unchangeable over large ranges and/or long times by integrating using Doppler (and/or range) information with angular information from gyros and bearing angle information from cameras.

### Aiding Sensor #6: Additional Camera

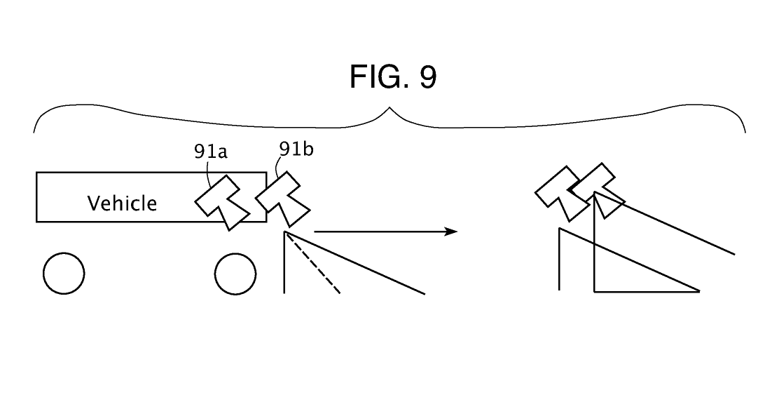

Another exemplary promising sensor combinations is to use two identical cameras mounted on the vehicle, one after another along main direction of motion and facing down and forward as depicted in FIG. 9a. If the cameras are synchronized and mounted on a common console platform with sufficient separation, they will produce overlapping images of the ground. We estimate that a two-camera system, by itself, should be able to keep the measurement of the traveled distance within 0.1% of accuracy. Thus, for a 10 km mission length and mission range, the two-camera system will be able to perform within the required 10 m accuracy level.

We claim:

1. A method for navigating a moving object (vehicle) utilizing a Navigation manager module and comprising the steps of:
Communicating with all sensors, processing units, mission manager and other vehicles navigation managers;
Configuring and reconfiguring sensors based on mission scenario objectives, in-vehicle and global constraints;
Sensor grouping according to relationship to the vehicle and environment, where an entire sensor group is seen by navigation manager as a single sensor;
Processing unit containing Update Filter; and,
Dynamically updated API database.

2. The method of claim 1, wherein said sensors are grouped into three groups according to:
relationship to the vehicle, environment and locality of the reference coordinate system.

3. The method of claim 2, wherein said update filter processing is separated into two channels: one with fixed number of states representing single point-vector on a vehicle; another with limited number of states representing local environment based on local processing and network throughput capabilities.

4. The method of claim 2, wherein said sensors can be comprised of different types including sensor-vehicle interaction and are supported through dynamically updated API database.

5. The method of claim 4, wherein said dynamical API database occurs before start of the mission.

6. The method of claim 4, wherein said dynamical API database occurs during the mission through network communication.

7. The method of claim 4, wherein said sensors are calibrated and recalibrated upon receiving calibration command from said Navigation manager module through said dedicated API.

8. The method of claim 4, wherein said sensors are turned off and on upon receiving on/off command from said Navigation manager module through said API.

9. The method of claim 3, wherein said vehicle is autonomous rigid vehicle.

10. The method of claim 3, wherein said vehicle is flexible vehicle (human), while each joint of said human vehicle is considered as rigid vehicle constrained by connections between joints.

11. The method of claim 3, wherein said vehicle is distributed rigid or flexible vehicle, with partially known and exchanged through network communication coordinates relationship between corresponding rigid vehicles.

12. The method of claim 4 wherein said sensor processing interface is simplified through abstractions and objects that include conversion of sensor measurement specifics into processing-common navigation objects.

13. The method of claim 12 wherein said sensors are distributed in each of three groups and can be mixed, selected and matched by processing according to their utility for the navigation.

14. The method of claim 13 wherein said three sensor groups are Vehicle-Referenced (VR) Sensors Group, Global (coordinates) Sensors Group (GSG) and Environment Features (EF) Sensing Group.

15. The method of claim 14, wherein each of 3 sensor groups
Communicates as single sensor through API with Navigation Manager;
Contains dynamic low-level API database;
Contains either Vehicle Sensor Map or Vehicle Feature Map or Distributed Vehicle Sensor Map;
Contains Timing Synchronizer;
Contains Measurement Merger; and
Contains vehicle Sensor calibration manager or Vehicle Feature Calibration manager.

16. The method of claim 15, wherein said Timing Synchronizer is allowed to send simultaneous or alternating measurement request to different sensors.

17. The method of claim 15, wherein said Measurement Merger merges measurements obtained from sensors through Timing Synchronizer, while adding, interpolating or extrapolating such measurements to achieve single rate output from each sensor group.

18. The method of claim 14, wherein said Environment Features (EF) Sensing Group has said Distributed-Vehicle Sensor Map formation functionality through said API network exchange with other vehicles.

19. The method of claim 18, wherein said Features (EF) Sensing Group Measurement Merger comprises:
Object Generator;
Object States Selector;
Measurements Selector; and
Coordinates Converter.

20. The method of claim 19, wherein said Object Generator has an ability to form multi-sensor-multi-feature objects according to Object Generation rules.

21. The method of claim 3 wherein said number of states update filter operates with single or dual rate; and limited number of states update filter operates with single rate.

22. The method of claim 21 wherein said fixed number of states update filter is an Extended Kalman Filter and limited number of states update filter is particle filter.

23. The method of claim 20 where Local Environment Map is constructed and updated, based upon only environmental features, currently senses by all sensors on distributed vehicle.

24. The method of claim 23 wherein an additional functionality of converting Local Maps in claim 23 into Global Environment map to achieve Simultaneous Localization and Mapping Capability (SLAM).
